(19) United States
(12) Patent Application Publication
(10) Pub. No.: US 2020/0090536 A1
(43) Pub. Date: Mar. 19, 2020

(54) CLASSROOM ASSISTANCE SYSTEM

(71) Applicant: Actiontec Electronics, Inc., Santa Clara, CA (US)

(72) Inventors: Bo XIONG, San Ramon, CA (US); Dean CHANG, Sunnyvale, CA (US); Chuang LI, Saratoga, CA (US)

(73) Assignee: Actiontec Electronics, Inc., Santa Clara, CA (US)

(21) Appl. No.: 16/551,668

(22) Filed: Aug. 26, 2019

Related U.S. Application Data
(60) Provisional application No. 62/722,834, filed on Aug. 25, 2018.

(51) Int. Cl. G09B 5/12; G06F 3/14; G06T 7/00; G06N 20/00

(52) U.S. Cl. CPC G09B 5/12; G06F 3/1423; G06T 2207/20081; G06N 20/00; G06T 7/0002

(57) ABSTRACT

Systems and methods involving machine learning functionality in a classroom setting are described to aid a teacher in certain teaching and administrative tasks. The classroom assistance system involves member devices used by students and at least one moderator device used by a teacher and may further involve an administrator device used by an administrator and a server. The member devices may display media content. The moderator device may include an image/audio input device and may execute machine learning engines running machine learning models that generate results indicative of student behavior, student comprehension and the appropriateness of media content. The teacher, using the moderator device, may provide feedback regarding the results. The member device may generate more than one type of result and one result may provide feedback with respect to the other result. Feedback may be used to train the machine learning model and generate improved models.

### TECHNICAL FIELD

The present disclosure relates, in general, to a classroom assistance system, and more particularly, to system for automating, facilitating and otherwise assisting classroom activities and generating data related to the classroom.

### BACKGROUND

A teacher is not only required to deliver a lesson plan each day, but also complete several administrative tasks as well as serve as a disciplinarian and maintain a safe and orderly classroom. Burdened by limited resources and ever increasing class sizes, these tasks are only becoming more difficult.

A teacher's primary responsibility is to educate. Specifically, a teacher must deliver the lesson plan for each day, carefully building on the concepts and subject matter taught the day before. As students' progress at different rates, a teacher must navigate the subject matter carefully so as not to leave a puzzled student behind while at the same time maintaining the interest of the more advanced students. To strike the right balance, a teacher must accurately gauge the general understanding of the class and move through the lesson plan accordingly. While test scores may help gauge the progress of the class, tests may be too infrequent to provide an accurate indication.

As students that have fallen behind or are too advanced for the subject matter may quickly lose interest, those students are at a higher risk for engaging in disruptive behavior. For this reason, in addition for general learning purposes, it is extremely important for the teacher to accurately gauge the classroom's overall progress and keep an appropriate pace.

The teacher must also keep a safe and orderly classroom and otherwise foster an environment in which students focus and learn. The ideal classroom setting is quiet so that students can hear the teacher and concentrate. For this reason, the teacher must stop students from speaking with one another or otherwise speaking out of turn during class time. Additionally, distracting behavior such as moving around (e.g., walking around) and/or abrupt movements (e.g., flailing arms) can detract from the learning environment. The teacher must quickly put a stop any behavior that distracts the other students. With a classroom of 20-30 students or more, it can be very difficult to immediately identify distracting behavior and ultimately keep order.

Computing devices complicate the task of keeping a safe and orderly classroom environment. Computing devices are now a common classroom tool and are frequently used by students to enhance the classroom experience and communicate with the teacher. However, computing devices in the classroom introduce a new set of challenges for the teacher. As not possible for the teacher observe each screen of each computing device at all times, students may use the computing devices to access inappropriate websites or media content (e.g., images, music, videos) and otherwise communicate with other students or individuals without the teacher's knowledge. The content displayed or played on the computing device may distract the student using the computing device as well as students in the vicinity of that computing device.

In addition to teaching the lesson plan and keeping order in the classroom, a teacher must also complete several administrative tasks. Accordingly, it is desirable to provide systems and methods that automate, facilitate or otherwise assist a teacher in performing classroom related tasks, permitting the teacher to dedicate more time and attention to teaching.

### SUMMARY OF THE INVENTION

The present invention is directed to a classroom assistance system for automating and assisting with certain classroom related tasks. The classroom assistance system preferably involves at least one moderator device used by a teacher or teacher's assistant and a plurality of member devices used by students. The moderator device and member devices include a display and a user interface. Each member device includes an image and/or audio input device for generating image and/or audio data. Each member device also includes a machine learning engine that runs one or more machine learning models locally on the member device.

The machine learning engines together with the machine learning models are designed to process the image and/or audio data, content data representative of media content displayed on the member device or otherwise played on the member device, and/or data related thereto to generate a result. The results generated by the member devices are indicative of whether the student is behaving, whether the student is comprehending the material taught, or whether the content data is appropriate for display on or to be played on the member device. The moderator device may be used by the teacher or assistant to review the results using the user interface on the moderator device. The teacher or assistant may identify results that are incorrect by observing the student in the classroom and/or reviewing a portion of the image/audio data and/or content data. The teacher may use the moderator device to transmit input data to the member device identifying a result as incorrect. The member device may train the machine learning model using the input data and generate an updated model.

The classroom assistant system may further include an administrator device used by an administrator of the school that may have the same functionality as the moderator device and communicate directly with the member devices and/or the moderator devices. The member devices, moderator devices, and/or administrator devices may also be in communication with a remote server.

### BRIEF DESCRIPTION OF THE DRAWINGS

FIG. 1 is a diagram illustrating a classroom assistance system.

FIG. 2 is a diagram illustrating the components of a classroom assistance system and the communication flow between the components.

FIGS. 3A-3C are schematic views of the electronic and hardware components of the member device, the moderator device and the administrator device.

FIGS. 4A-4C are schematic views of the software components of the member device, the moderator device and the administrator device.

FIG. 5 illustrates exemplary parameters for facial analysis.

FIG. 6 is a flow chart illustrating the operations and decisions made in implementing the machine learning functionality of the classroom assistance system.

FIG. 7 is illustrates a results record detailing results generated and feedback.

FIG. 8 is an exemplary view of a behavior classification interface displayed on a moderator device and/or an administrator device.

FIG. 9 is an exemplary view of a comprehension classification interface displayed on a moderator device and/or an administrator device.

FIG. 10 is an exemplary view a content classification interface displayed on a moderator device and/or administrator device.

FIG. 11 is an exemplary view of a content classification interface having a summary section displayed on a moderator device and/or administrator device.

FIG. 12 is an exemplary view of a behavior classification interface displayed on a moderator device and/or administrator device.

FIGS. 13A-13F illustrate graphical representations of the data generated by the classroom assistance system.

The foregoing and other features of the present invention will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION OF THE INVENTION

The present invention is directed to a classroom assistance system having machine learning capabilities to facilitate and automate various activities in a classroom setting and generate data relevant to a classroom setting. Classroom assistance system involves one or more member devices, one or more moderator devices, and may optionally include one or more administrator devices and one or more remote servers. Member devices are used by students, moderator devices are used by teachers and/or teacher's assistants and administrator devices are used by school administrators. The member devices are configured to run one or more machine learning models on one or more machine learning engine. The machine learning models may be initially trained for one or more purposes and may be further trained and updated using feedback from the moderator devices and/or administrator devices.

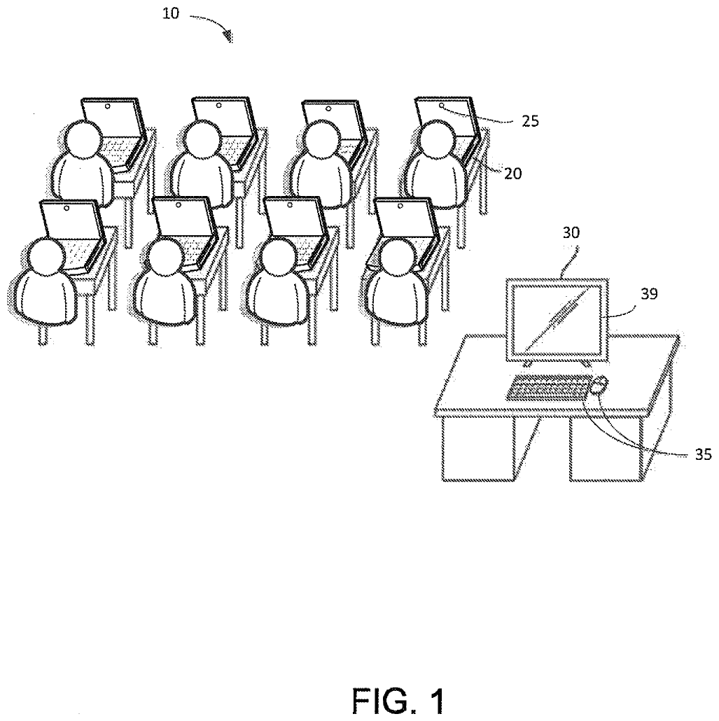

As is shown in FIG. 1, classroom assistance system 10 includes at least one member device 20 and at least one moderator device 30. Member device 20 may be any device having processing power, storage, network connectivity and image/audio input device 25. Image/audio input device 25 may be a camera, videorecorder, microphone, and/or any other image, video or audio device incorporated in or combined with member device 20. Image/audio input device 25 may generate image/audio data including any type of audio data, infrared images, night vision, thermal images, and any other types of imaging. Preferably, image/audio input device 25 is directed toward the user of member device 20 when member device 20 is in operation. Moderator device 30 may be any device having processing power, storage, network connectivity, display 39 and moderator input device 35. Moderator input device 35 may be a keyboard, mouse, track pad, touch screen, speaker and/or any other device that communicates data to moderator device 30. Member device 20 and/or moderator device 30 may be a personal computer, laptop, tablet or smart phone or any other computing device having the features described above.

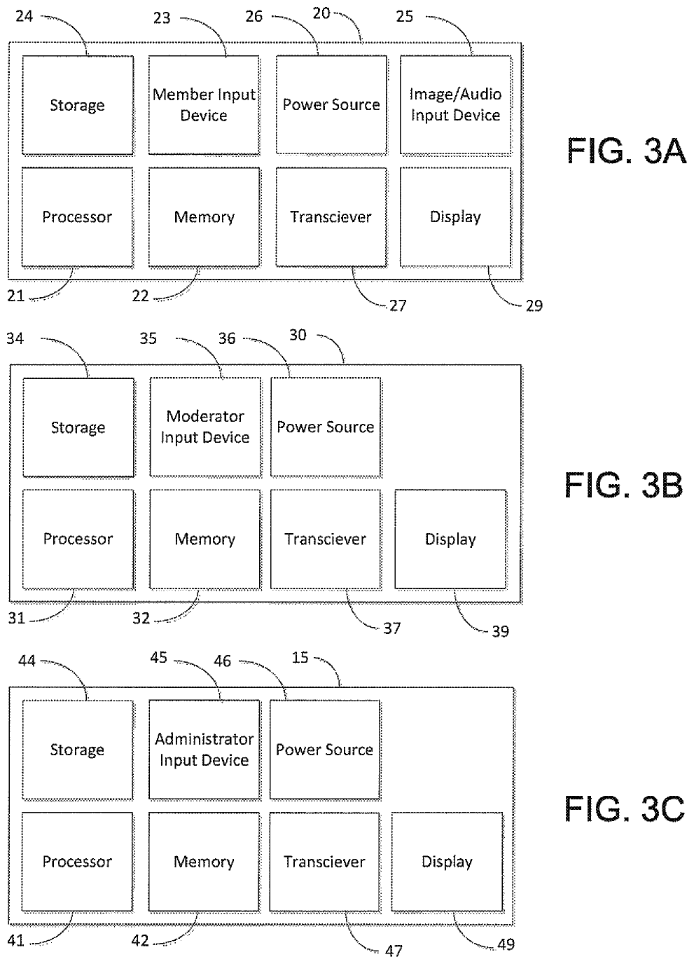

Member devices 20 and moderator device 30 may communicate directly via any well-known wired or wireless connection (e.g., Wi-Fi Direct (P2P), Bluetooth™, Bluetooth™ Low Energy (BLE)). Moderator device 30 may optionally include access point 68, explained in greater detail with respect to FIG. 3B. For example, in the configuration shown in FIG. 1, which includes only member devices 20 and moderator device 30, member device 20 and moderator device 30 may connect and communicate via access point 68.

Though FIG. 1 illustrates eight member devices 20 and one moderator device 30, it of course will be understood that any different number of member devices and moderator devices may be used. It will further be understood that member device 20 and moderator device 30 may be the same or different type of device. Additionally, each member device 20 in classroom assistance system 10 may be the same or different type of device. While classroom assistance system may optionally include additional devices (e.g., administrator device 15, remote server 5), it is understood that classroom assistance system 10 may only include moderator devices 30 and member devices 20.

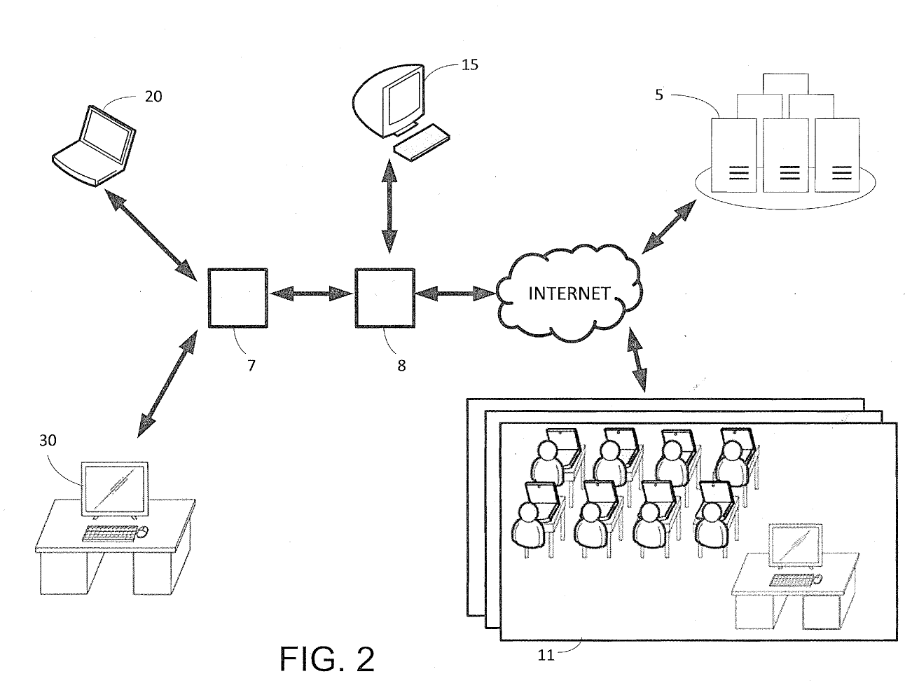

Referring now to FIG. 2, classroom assistance system 10 may further optionally include one or more administrator devices 15 and one or more remote server 5 as well as at least one access point 7 and network interface 8. Administrator device 15 may be any device having processing power, storage, network connectivity and administrator input device 45. Administrator input device 45 may be a keyboard, mouse, track pad, touch screen, speaker and/or any other device that communicates data to administrator device 15. Administrator device 15 may be a personal computer, laptop, tablet or smart phone or any other similar device having the features described above. Remote server 5 is one or more servers that is hosted and delivered through a cloud computing platform over the Internet.

In the configuration illustrated in FIG. 2, member device 20 and moderator device 30 may connect and communicate via access point 7 over a wired or wireless connection over any well-known standard such as any IEEE 802 standard. Access point 7 may serve as an access point and generate a local area network (LAN). Access point 7 may be located in or near the classroom in which member device 20 and moderator device 30 are located. Alternatively, where access point 68 is incorporated into moderator device 30, access point 68 may serve as access point 7. Access point 7 may communicate via a well-known wired or wireless connection to network interface 8. Network interface 8 may be located on the school grounds but away from the classroom in which member device 20 and moderator device 30 are located. Alternatively, network interface 8 may be located near access point 7 or access point 7 may be incorporated into network interface 8. Administrator device 15 may also connect to network interface 8 over any well-known wired or wireless connection or via a different access point that is also in communication with network interface 8. Network interface 8 may connect devices of classroom assistance system 10 (e.g., moderator devices 30, member devices 20 and/or administrator devices 15) to the Internet using well known technology (e.g., cable/coaxial or DSL).

Moderator device 30, member device 20 and/or administrator device 15 may optionally be in communication with remote server 5 via the internet. Moderator device 30 and/or administrator device 15 may also optionally be in communication with one or more other classrooms 11 via the internet. Other classrooms 11 may include one or more member devices and/or one or more moderator devices. Alternatively, other classrooms 11 may only include member devices as a teacher using moderator device 30 may remotely teach the students in other classrooms 11. Other classrooms 11 may be on the school grounds or may be located off campus or on another campus.

Though FIG. 2 illustrates one moderator device in each classroom and one administrator device, it of course will be understood that any different number of moderator devices and administrator devices may be used. For example, classroom assistance system 10 may include three classrooms but only one moderator device 30. In this configuration, a teacher using moderator device 30 may be located in one of the three classrooms and may remotely teach and oversee the students in the other two classrooms. The member devices in the classrooms without the teacher may communicate with the moderate device over the Internet. It will further be understood that moderator device may optionally be eliminated from classroom assistance system 10 and administrator device 15 may perform the functionality of moderator device 30.

Referring now to FIG. 3A-C, exemplary functional blocks representing the electronic and hardware components of member device 20, moderator device 30 and administrator device 15 are shown. Referring now to FIG. 3A, member device 20 may include processor 21 coupled to memory 22, such as flash memory, electrically erasable programmable read only memory, and/or volatile memory. Processor 21 is suitable for image and/or audio data analytics, content data analytics and machine learning computation and is configured to run member application 28 and the subcomponents thereof. Member device 20 may further include member input device 23, storage 24, power source 26, transceiver 27, image/audio input device 25, and display 29. Storage 24 may be a solid state device, magnetic disk or optical disk. Power source 26 may be a battery or may connect member device 20 to a wall outlet. Transceiver 27 receives and/or transmits information to and from member device 20 to other devices in classroom assistance system 10. Display 29 displays media content and user interface 59. It of course is understood that member device 20 may include additional or fewer components than those illustrated in FIG. 3A, such as speakers, and may include more than one of each type of component.

Referring now to FIG. 3B, exemplary functional blocks representing the electronic and hardware components of moderator device 30 are shown. In particular, moderator device 30 may include processor 31 coupled to memory 32, such as flash memory, electrically erasable programmable read only memory, and/or volatile memory. Processor 31 is suitable for generating graphical representations and running moderator application 38. Moderator device 30 may further include storage 34, power source 36, transceiver 37, moderator input device 35 and display 39. Storage 34 may be a solid state device, magnetic disk or optical disk. Power source 36 may be a battery or may connect moderator device 30 to a wall outlet. Transceiver 37 receives and/or transmits information to and from moderator device 30 to other devices in classroom assistance system 10. Display 39 displays user interface 64. It is of course understood that moderator device 30 may include additional or fewer components than those illustrated in FIG. 3B and may include more than one of each type of component.

Referring now to FIG. 3C, exemplary functional blocks representing the electronic and hardware components of administrator device 15 are shown. In particular, administrator device 15 may include processor 41 coupled to memory 42, such as flash memory, electrically erasable programmable read only memory, and/or volatile memory. Processor 41 is suitable for running administrator application 48. Processor 41 may further include, storage 44, transceiver 47, power source 46, administrator input device 45 and display 49. Storage 44 may be a solid state device, magnetic disk or optical disk. Power source 46 may be a battery or may connect administrator device 15 to a wall outlet. Transceiver 47 receives and/or transmits information to and from administrator device 15. Display 29 displays user interface 74. It of course is understood that administrator device 15 may include additional or fewer components than those illustrated in FIG. 3C and may include more than one of each type of component.

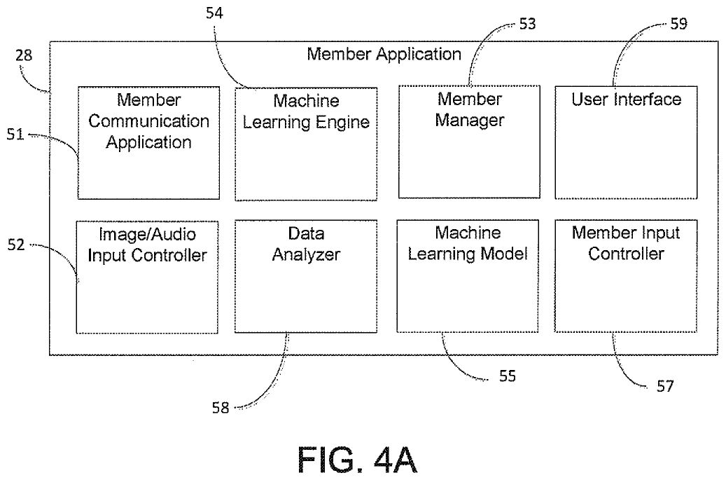

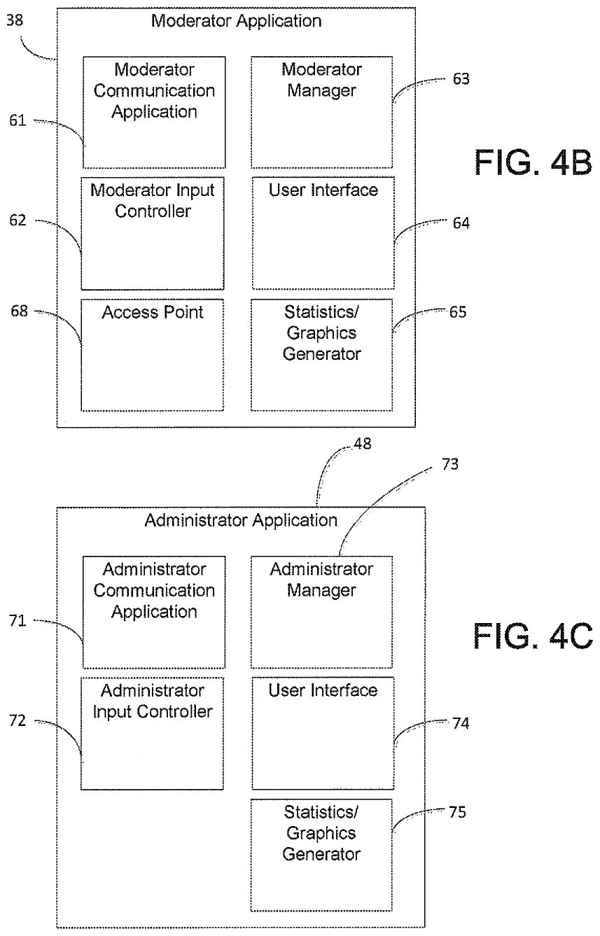

Referring now to FIGS. 4A-C, member application 28, moderator application 38, and administrator application 48 are non-transitory computer readable medium that may be run on member device 20, moderator device 30, and administrator device 15, respectively. Member application 28 and moderator application 38 and, optionally, administrator application 48 together oversee and otherwise facilitate the operations and actions of classroom assistance system 10.

Member application 28, illustrated in FIG. 4A, oversees the actions and operations of classroom assistance system 10 performed on member device 20. Member application 28 may include several subcomponents such as member communication application 51, image/audio input controller 52, member manager 53, data analyzer 58, machine learning engine 54, machine learning model 55, user interface 59 and member input controller 57. It is understood that member application 28 may include greater or fewer subcomponents such as more than one machine learning model.

Member communication application 51 facilitates data communication with other devices in classroom assistance system 10 including moderator device 30 and, optionally, administrator device 15. For example, member communication application 51 may receive data from moderator device 30 and/or administrator device 15 and communicate the data to one or more subcomponents of member application 28. Additionally, member communication application 51 may receive data from one or more subcomponents of member application 28 and communicate the data to moderator device 30 and/or administrator device 15.

Member manager 53 operates image/audio input device 25 (e.g., via image/audio input controller 52) to capture, generate or otherwise obtain images and/or audio data. Alternatively, moderator device 30 and/or administrator device 15 may be authorized to instruct image/audio input device 25 to capture, generate or otherwise obtain images and/or audio data. Member manager 53 may provide the image and/or audio data to data analyzer 58 and/or machine learning engine 54. Member application 28 may also obtain or otherwise capture data representative of the content displayed on user interface 59, played (e.g., on speakers of member device 20), generated on, and/or accessed by member device 20, referred to as content data. Content data may be communicated to data analyzer 58 and/or machine learning engine 54. For example, member manager 53 may be tasked with obtaining this data and communicating the data to data analyzer 58 and/or machine learning engine 54. Member application 28 may also place the image and/or audio data and/or content data, or a portion thereof, in storage 24 and/or send the image and/or audio data and/or content data, or a portion thereof, to remote server 5. Some or all of the image and/or audio data and/or content data may also be sent, automatically or at the request of the teacher, assistant and/or administrator, to moderator device 30 and/or administrator device 15.

User interface 59 may generate and display text, images, videos and other content on member device 20. Member input device 23 may be used by the student to input information into member application 28 and generally may be used to control and interact with member device 20. The data generated by member input device 23 may be managed by member input controller 57 and shared with various subcomponents of member application 28. Member input device 23 may be used to manipulate and otherwise select media content displayed, generated or otherwise accessed by member device 20.

Data analyzer 58 may analyze data generated by image/audio input device 25 and/or content data and generate analyzed data according to certain parameters or filters. For example, data analyzer 58 may implement well known facial recognition and/or voice recognition functionality. In yet another example, data analyzer 58 may implement well known image and/or text recognition functionality. Data analyzer 58 may take raw data generated by image/audio input device 25 and/or content data and may condition the data such that it may be applied to and processed by machine learning engine 54 running machine learning model 55. It is understood that data analyzer 58 may be a stand-alone subcomponent or may be integrated with or otherwise embedded into in machine learning engine 54. It is further understood that member device 20 may not include data analyzer 58 and raw data generated by image/audio input device 25 and/or content data may be processed by machine learning engine 54, as described below.

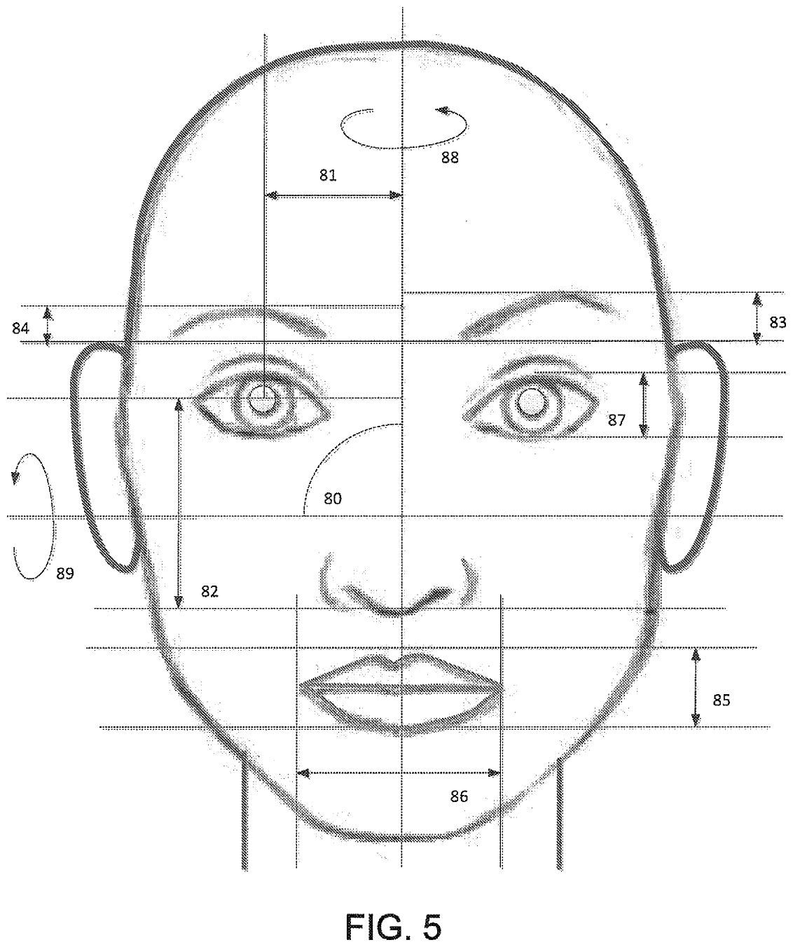

FIG. 5 illustrates exemplary parameters that may be used to analyze an image of a face. As is shown in FIG. 5, data analyzer 58 may make one or more of the following measurements: distance 81 between the pupil and the vertical centerline of the face, distance 82 between the pupil and horizontal centerline of the face, distance 83 between the apex of the left eyebrow and the top of the left ear, distance 84 between the apex of the right eyebrow and the top of the right ear, distance 85 between the top of the mouth and the bottom of the mouth, distance 86 between the left side of the mouth and the right side of the mouth, distance 87 between the top eyelid and the bottom eyelid, angle 80 which is the angle the head is tilted from the vertical centerline of the face, angle 88 which is the angle the head is rotated about the vertical axis, and angle of rotation 89 which is the angle the head is titled about the horizontal axis. It is understood that the parameters illustrated in FIG. 5 are exemplary and that any other parameters could be used to analyze the image data. It is similarly understood that other parameters could similarly be used to analyze audio data such as parameters relating to pitch, tone, inflections, etc.

The parameters used by data analyzer 58 may be preprogrammed and unalterable or may be updated and altered using moderator device 30, administrator device 15 and/or or remote server 5. Alternatively, the parameters of data analyzer 58 may be selected or updated via a system operator remote from classroom assistance system 10 that connects to and/or communicates with member device 20 via the internet. The analyzed data generated by data analyzer 58 may be communicated to machine learning engine 54. Alternatively, where the data generated by image/audio input device 25 and/or content data is suitable for application to and processing by machine learning engine 54 running machine learning model 55, the data generated by image/audio input device 25 and/or content data may not be applied to data analyzer 58 and instead may be directly provided to machine learning engine 54. For example, member manager 53 may communicate this data directly to machine learning engine 54.

Machine learning engine 54 is one or more machine learning engines that execute machine learning and deep learning algorithms to generate and train machine learning models. It is understood that more than one machine learning engine may simultaneously run one or more machine learning models. Using machine learning engine 54, one or more machine learning models may be trained to generate a certain result. Machine learning engine 54 is configured to run machine learning model 55 to process data and produce a result. Machine learning model 55 is a computer model that may be a single machine learning model trained for one or more purposes or may be a collection of machine learning models, each trained for a specific purpose. Machine learning model 55 may be originally trained by a computer outside of classroom assistance system 10 that may have processing power superior to that of member device 20. Machine learning model 55 may be updated or replaced with an improved model. The original model and/or the updated model may be saved to member device 20 or may be retrieved by member device 20 from remote server 5. For example, a new or improved model may be saved to remote server 5 and retrieved by member device 20 or may be transmitted to member device 20 or caused to be downloaded on member device 20 as part of a software update.

Referring now to FIG. 4B, moderator application 38 oversees the actions and operations of classroom assistance system 10 performed on moderator device 30. Moderator application 38 may include subcomponents such as moderator communication application 61, moderator input controller 62, moderator manager 63 and user interface 64. Moderator device 30 may also optionally include subcomponents such as statistics/graphics generator 65 and access point 68. It is understood that moderator device 30 may include greater or fewer subcomponents.

Moderator communication application 61 facilitates data communication with other devices in classroom assistance system 10 including member device 20 and optionally administrator device 15. For example, moderator communication application 61 may receive data from member device 20 and/or administrator device 15 and deliver that data to one or more subcomponents of moderator application 38. Additionally, moderator communication application 61 may receive data from one or more subcomponents of moderator application 38 and communicate that data to member device 20 and/or administrator device 15. Access point 68 may serve as an access point and generate a local area network (LAN) to connect member devices 20 and moderator device 30 and optionally other devices in classroom assistance system 10 such as administrator device 15. Where classroom assistance system 10 includes access point 7, moderator device 30 may not include separate access point 68.

User interface 64 may generate and display images corresponding to data received from member device 20, administrator device 15 and/or input generated by moderator input device 35. For example, user interface 64 may display behavior classification interface 141, comprehension classification interface 171 and/or content classification interfaces 191 and 201. Moderator input device 35 may be used by the teacher or teacher's assistant to input information into moderator application 38. The data generated by moderator input device 35 is communicated to moderator input controller 62. Moderator input controller 62 may place data generated by moderator input device 35 in storage 34 and/or remote server 5. Moderator manager 63 may facilitate the transfer of data generated by moderator input device 35 to user interface 64 for display. Moderator manager 63 may also coordinate with moderator communication application 61 to send the data generated by moderator input device 35 to other members of classroom assistance system 10 such as member device 20.

Moderator manager 63 may provide data received from member device 20 to statistics/graphics generator 65. Statistics/graphics generator 65 may evaluate and run computational analysis on data received from member device 20. Moderator manager 63 may further coordinate with member devices, 20 and/or moderator devices 30 of other classrooms 11 and/or administrator devices 15 to obtain additional data. Statistics/graphics generator 65 may generate graphical representations and statistical analysis which may be displayed on moderator device 30 via user interface 64. The analysis generated by statistics/graphics generator 65 may be stored on storage 34 and/or remote server 5.

Referring now to FIG. 4C, administrator application 48 oversees the actions and operations of classroom assistance system 10 performed on administrator device 15. Administrator application 48 may include subcomponents such as administrator communication application 71, administrator input controller 72, administrator manager 73 and user interface 74. Administrator device 15 may also optionally include other subcomponents such as statistics/graphics generator 75. It is understood that administrator device 15 may include greater or fewer subcomponents.

Administrator communication application 71 facilitates data communication with other devices in classroom assistance system 10 including member device 20 and moderator device 30. For example, administrator communication application 71 may receive data from member device 20 and deliver that data to one or more subcomponents of administrator application 48. Additionally, administrator communication application 71 may receive data from one or more subcomponents of administrator application 48 and communicate that data to member device 20.

User interface 74 may generate and display images corresponding to data received from member device 20, moderator device 30 and/or input generated by administrator input device 45. Administrator input device 45 may be used by the administrator to input information into administrator application 48. The data generated by administrator input device 45 is communicated to administrator input controller 72. Administrator input controller 72 may place data generated by administrator input device 45 in storage 44 and/or remote server 5. Administrator manager 73 may coordinate with administrator communication application 71 to send the data generated by administrator input device 45 to member device 20. Administrator manager 73 may also facilitate the transfer of data generated by member device 20 and/or administrator input device 45 to user interface 74 for display.

Administrator manager 73 may provide data received from member device 20 to statistics/graphics generator 75. Statistics/graphics generator 75 may evaluate and run computational analysis on data received from member device 20 and/or moderator device 30. Administrator manager 73 may further coordinate with member devices, 20 and/or moderator devices 30 of other classrooms 11 and/or other administrator devices 15 to obtain additional data. Statistics/graphics generator 75 may generate graphical representations and statistical analysis which may be displayed on administrator device 15 via user interface 74. The analysis generated by statistics/graphics generator 75 may be stored on storage 44 and/or remote server 5.

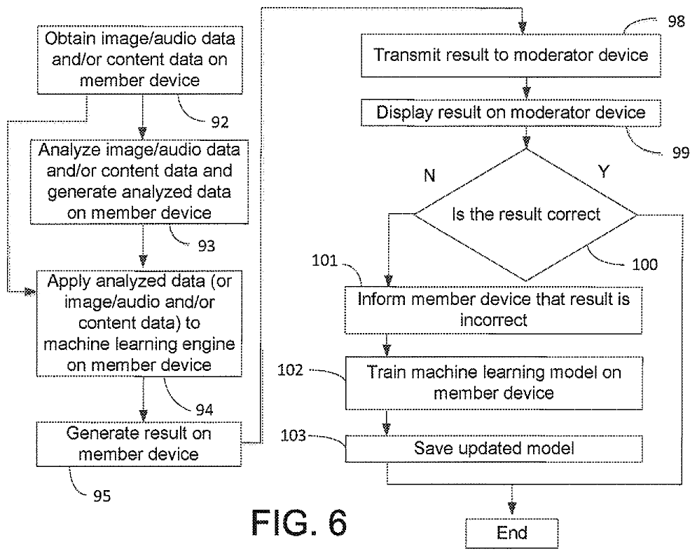

Referring now to FIG. 6, a flowchart is illustrated detailing the data flow and decisions made in implementing the machine learning functionality of classroom assistance system 10. As mentioned above, classroom assistance system 10 may be used to generate a result by applying analyzed data generated by data analyzer 58, or in some cases the data generated by image/audio input device 25 and/or content data, to machine learning engine 54 runs machine learning model 55. The result will inform the teacher or assistant using moderator device 30 of certain conditions or information regarding the student and/or member device 20 used by the student. If the result is incorrect, the teacher or assistant may inform the member device, using moderator input device 35, that the result generated is incorrect, and that information, referred to as input data, will be used to retrain machine learning model 55. While the process set forth in FIG. 6 is described with respect to member device 20 and moderator device 30, it is understood that administrator device 15 may perform the steps and functionality described with respect to moderator device 30.

To initiate the process set forth in FIG. 6, at step 92 image/audio input device 25 generates, captures and/or obtains image and/or audio data. Alternatively, or additionally, member application 28 obtains content data representative of the content displayed on user interface 59 or otherwise played or accessed by member device 20. At step 93, the image and/or audio data and/or content data is communicated to data analyzer 58 to analyze the image and/or audio data and/or content data using a set of parameters or filters to generate analyzed data. At step 94 the analyzed data is communicated and applied to machine learning engine 54. Alternatively, as explained above, the image and/or audio data or content data obtained at step 92 may be communicated and applied directly to machine learning engine 54 at step 94.

Upon receiving the analyzed data or image/audio data and/or content data at step 94, machine learning engine 54, running machine learning model 55, will process the data and generate a result. It is understood that machine learning model 55 may be a single machine learning model or may be a collection of multiple machine learning models. Where machine learning model 55 involves multiple machine learning models, machine learning engine 54 may simultaneously run multiple machine learning models. Where machine learning engine 54 involves multiple machine learning engines, the multiple machine learning engines may each simultaneously run multiple machine learning models.

Machine learning model 55 may be trained for one or more purposes and may process one or more types of data. For example, machine learning model 55 may include a first machine learning model that processes image/audio data to generate a result based on the image/audio data and a second machine learning model that processes content data to generate a result based on content data. Results based on the content data may be used to supplement or verify the results based on image/audio data, and vice versa. For example, a result based on image/audio data may suggest that the student is not paying attention. The teacher may confirm that the student is not paying attention by looking at the result based on content data which may indicate that the student is viewing inappropriate content. Alternatively, or in addition to, machine learning model 55 may include a machine learning model that processes both image/audio data and content data to generate a result based on both types of data. For example, that a student is viewing inappropriate content could be one factor that may be considered along with other facial and behavior cues in determining whether a student is paying attention.

The result generated by machine learning engine 54 running machine learning model 55 may correspond to or involve a percent of confidence or other weighted value. For example, the result may correspond to a percent of confidence that a student is acting inappropriately. A high percent may suggest that the system is very confident that the student is acting inappropriately. A low percent may suggest that the system is not sure if the student is acting inappropriately, or alternatively, a high degree ofconfidence that the student is not acting inappropriately.

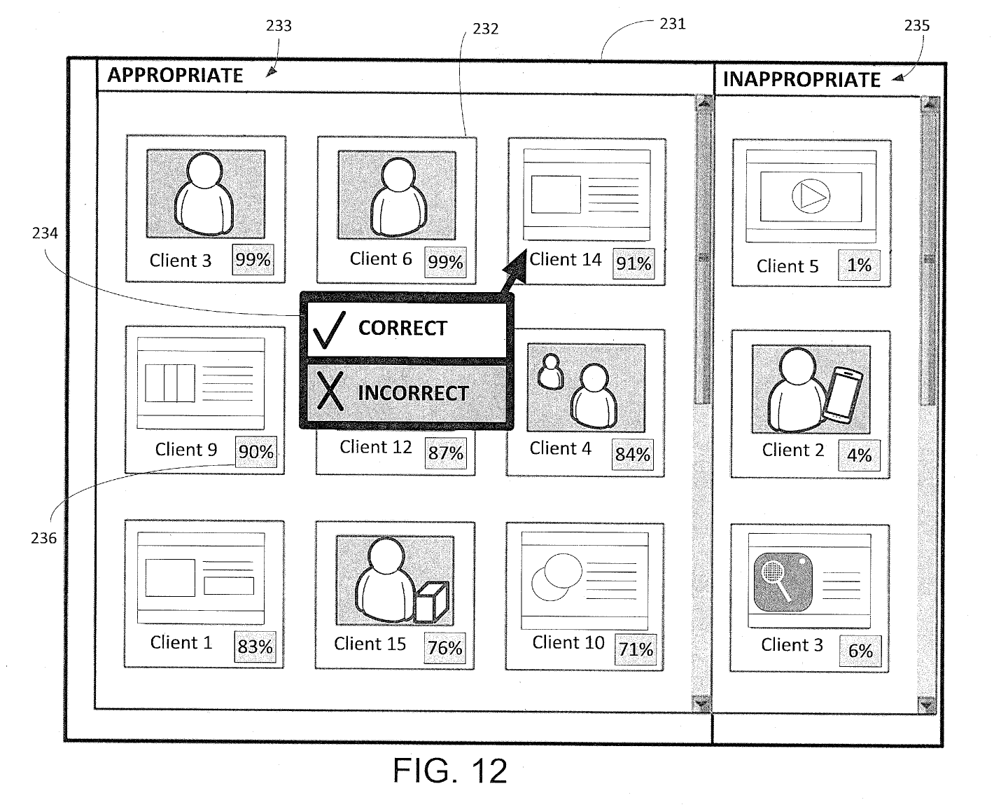

It is understood that the percent of confidence or weighted result based on image/audio data and the percent of confidence or weighted result based on content data may be combined together to generate a combined result with greater accuracy, illustrated in FIG. 12. For example, to determine whether a student is acting inappropriately, the confidence percentage of the result based on the image/audio data may be averaged with the confidence percentage based on the content data, or otherwise combined, to generate a more accurate result.

Member application 28 may be programmed to infer a result if a threshold percent of confidence is achieved (e.g., 70%). The threshold may be preprogrammed and/or altered by member device 20, administrator device 15 or a device outside of classroom assistance system 10. If the threshold is achieved, member application 28 may suggest or infer that the student is behaving, comprehending the subject matter, acting appropriately, viewing appropriate content, etc.

In one example, machine learning model 55 may be a computer model trained to determine whether a student is behaving or misbehaving. Specifically, machine learning model 55 may trained to recognize traits of a student that is misbehaving, not paying attention otherwise acting inappropriately. For example, machine learning model 55 may identify when a student is sleeping, not looking at the teacher, viewing or playing inappropriate media content, speaking out of turn, making unusual or distracting movements, making unusual sounds, or otherwise behaving in a manner that detracts from the learning environment. If traits of misbehavior are identified, a result will be generated by machine learning engine 54 running machine learning model 55 indicative of the student misbehaving.

Alternatively, or in addition to, machine learning model 55 may be a computer model trained to determine whether a student is comprehending the subject matter taught. Specifically, machine learning model 55 may be trained to recognize traits of a student that comprehends the material or alternatively is confused or frustrated. For example, machine learning model may identify puzzled facial expressions (e.g. raised eyebrows and downward head inclination) or signs of comprehension (e.g., consistent eye contact and head nodding). If traits of comprehension are identified, a result will be generated by machine learning engine 54 running machine learning model 55 indicative of the student comprehending the subject matter.

Alternatively, or in addition to, machine learning model 55 may be trained to determine if a student is present or absent, or in conformity with a certain dress code by analyzing the attire of a particular student. Additionally, machine learning model 55 may be trained to identify if a student is angry, sick or hurt, or needs immediate help or may even identify bullying (e.g., physical aggression, taunting, etc.). Machine learning model 55 may also be trained to identify dangerous objects (e.g., guns, knives, explosives, etc.) or dangerous conditions (e.g., fire, loud noises such as explosions or gun fire, etc.) and may signal an alarm and/or immediately alert the appropriate authorities.

Alternatively, or in addition to, machine learning model 55 may be trained to identify inappropriate content displayed on member device 20 or otherwise played or accessed on member device 20. For example, machine learning model 55 may identify when a student is accessing an inappropriate website (e.g., social media websites), displaying inappropriate images (e.g., weapons or drugs), playing an inappropriate video clip (e.g., sports video) or even playing music or other audio clips. If inappropriate content is identified, a result will be generated by machine learning engine 54 running machine learning model 55 indicative of inappropriate content being displayed or played by member device 20.

After a result is generated at step 95, at step 98 member device 20 will inform moderator device 30 of the result. For example, member communication application 51 may inform moderator communication application 61 of moderator device 30 of the result. At step 99, moderator device 30 will display the result via user interface 64.

Member device 20 may optionally be programmed to transmit some or all of image and/or audio data and/or content data to moderator device 30 and/or administrator device 15. For example, member device 20 may be set to always transmit a portion of the relevant data to moderator device 30 and/or administrator device 15 upon generating a result. Alternatively, member device 20 may be designed to only transmit some or all of the relevant data upon receiving a request from moderator device 30 and/or administrator device 15. In yet another example, member device 20 may be designed to only transmit some or all of the relevant data for certain types of results. Member device 20 may alternatively, or additionally, transmit some or all of the image and/or audio data and/or content data to remote server 5 for retrieval by moderator device 30 and/or administrator device 15.

Member device 20 may also optionally be programmed to execute a particular operation if a certain result is generated. For example, member device 20 may be programmed to shut down a web browser, a single tab on the web browser, an application run the member device (e.g., media player), or shut down the entire member device 20. Upon executing this operation, member device 20 may inform moderator device 30 and/or administrator device 15 that the operation was executed in response to the result. Alternatively, member device 20 may suggest to moderator device 30 and/or administrator device 15 that one of the foregoing corrective actions should be initiated in response to the result and request permission from moderator device 30 to take such action. Member device 20 may offer moderator device 30 and/or administrator device 15 a list of proposed corrective actions to choose from.

At decision 100, the teacher or assistant using moderator device 30 will determine whether the result is correct. This decision may be made by the teacher or assistant by visually observing the student in the classroom or by observing the media content displayed or played on member device 20. Alternatively, the teacher or assistant may review the image and/or audio data and/or content data transmitted by member device 20, if such image and/or audio data and/or content data was transmitted. A teacher or assistant using moderator device 30 may elect to take a closer look at the student or content on member device by either activating image/audio input device 25 or by mirroring the display of member device 20 on moderator device 30 and reviewing the image/audio data or mirrored display in real time or near real time.

If it is determined at decision 100 that the result is indeed correct, the teacher/assistant does not need to take any further action. If it is instead determined at decision 100 that the result is incorrect, at step 101 the teacher or assistant using moderator device 30 may inform member device 20 that the result is incorrect. For example, using moderator input device 35 to interact with user interface 64, the teacher or assistant may generate input data corresponding to the result being incorrect and moderator device 30 via moderator communication application 61 may communicate the input data to member device 20 via member communication application 51.

Upon member device 20 being informed that the result is not correct, at step 102 machine learning engine 54 will train machine learning model 55 using the input data received from moderator device 30 and generate an updated machine learning model. Where a second result is used to determine that a first result is incorrect, the second result and/or some or all of the data (i.e., image/audio data or content data) that the second results is based on may be used to train the machine learning model to generate an updated machine learning model. At step 103, the updated machine learning model will be saved locally on member device 20 and will become the default machine learning model implemented in step 95. The updated machine learning model may optionally be sent to remote server 5 for remote storage.

Training the original machine learning model as described above will improve the accuracy of the system as the system learns to account for variations in student behavior such as, for example, the student's general temperament, behavioral ticks, fatigue, illness and/or emotions. Machine learning model 55 will also learn to better recognize inappropriate content. For example, though an initial machine learning model may be trained to classify content relating to music as inappropriate, in the context of a music appreciation class the machine learning model will be trained to treat this media content as appropriate in response to the feedback (i.e., input data) received from moderator device 30.

It is understood that steps 92-98 of FIG. 6 and methods and operations related thereto may be initiated at the direction of moderator device 30 and/or administrator device 15. Alternatively, steps 92-98 may be preset to occur at set periods of time. Accordingly, a teacher or assistant using moderator device 30 and/or an administrator using administrator device 15 may initiate the methods and operations described in FIG. 6 at will or may rely on automated initiation according to preset periods of time.

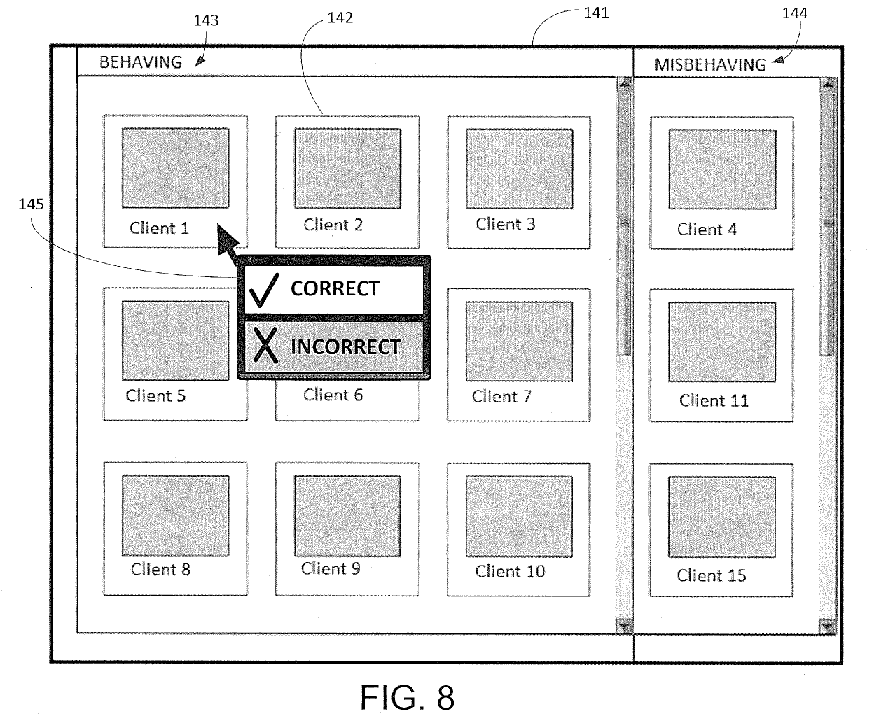

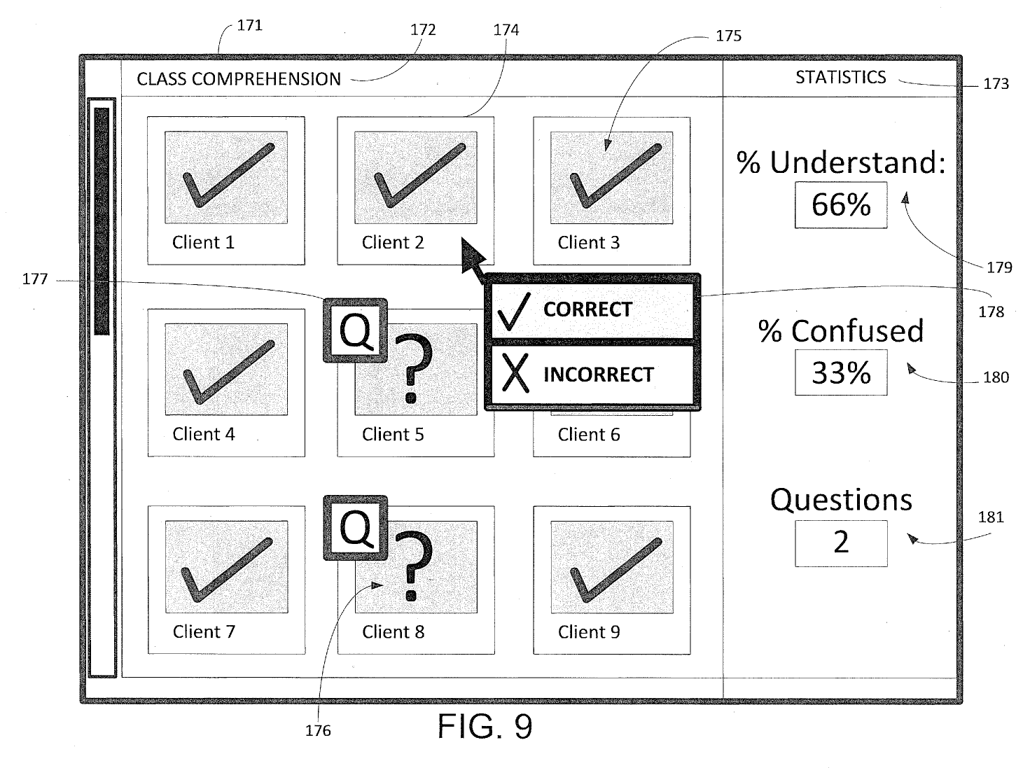

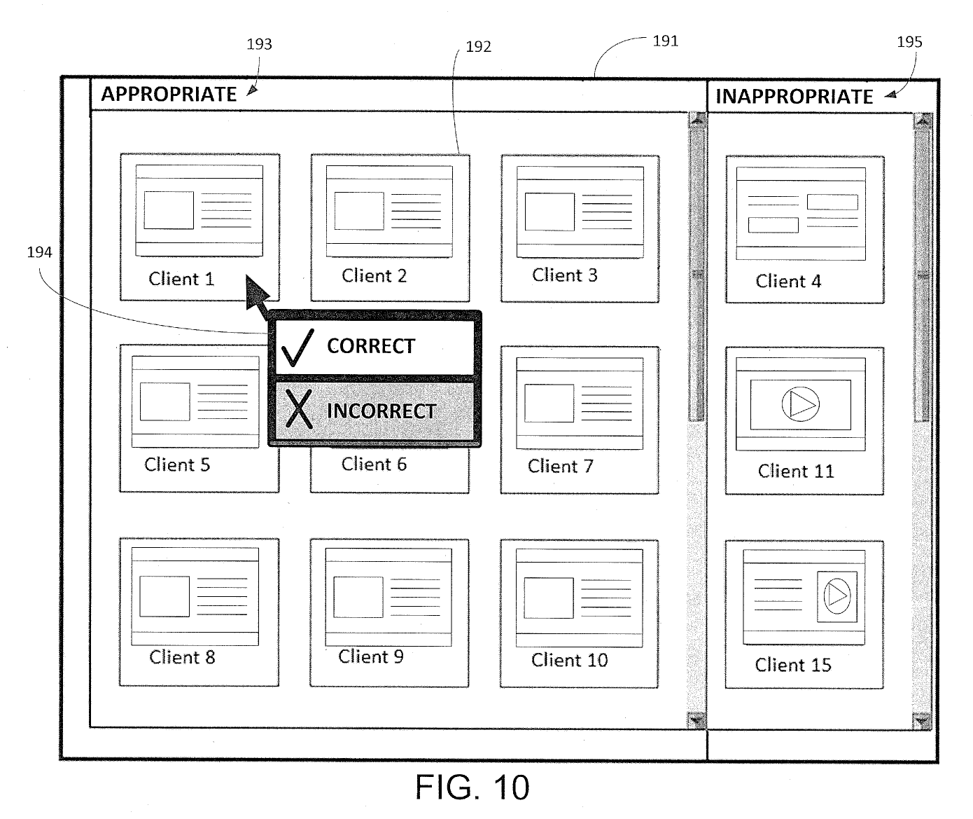

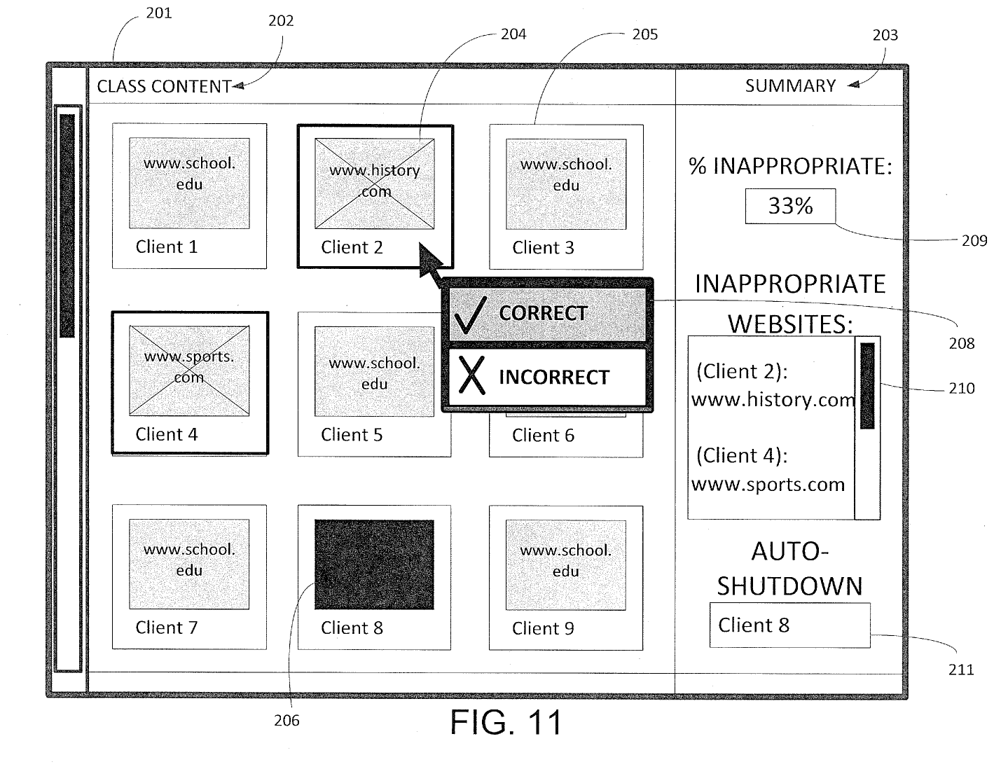

The data flow and decisions made in implementing the machine learning functionality illustrated in FIG. 6 may be implemented for each member device 20 in classroom assistance system 10. Accordingly, each machine learning engine 54 on each member device 20 will generate a result and communicate that result to moderator device 30 and/or administrator device 15. Behavior classification interface 141, illustrated in FIG. 8, comprehension classification interface 171, illustrated in FIG. 9, and content classification interfaces 191 and 201, illustrated in FIGS. 10 and 11, are exemplary user interfaces displayed on user interface 64 of moderator device 30 and/or user interface 74 of administrator device 15 that aggregate and display the results generated by all member devices 20. While these figures illustrate examples of interfaces that aggregate and display the results, it is understood that the results generated by member devices 20 may be displayed in any manner or arrangement suitable for displaying the results.

Where two machine learning models are executed simultaneously and each generate a result, the second result may be used to determine at decision 100 that the first result is incorrect. For example, member device 20 may generate both image data and content data and first machine learning model may be run on a machine learning engine to generate a first result based on the image data and a second machine learning model may be simultaneously run on the same or a different machine learning engine to generate a second result based on the content data. In this example, the result based on content data may be used by member application 28 to determine that the result based on image data is incorrect.

Member application 28 may compare the first and second result according to preprogrammed instructions. Where each result corresponds to a certain confidence percentage or a weighted value, member application 28 may be programmed to determine that the first result is incorrect if the confidence percentage or weighted value of the second result exceeds a certain threshold value. For example, member application 28 may include a first result based on image data that indicates that a student is paying attention if a confidence percentage of the first result is above 50%, and a second result based on content data that indicates that a student is viewing inappropriate content on member device 20 if a confidence percentage of the second result is below 50%. Member application 28 may be programmed to determine that a first result indicative of a student paying attention is incorrect if the second result corresponds to a confidence percentage below 50%. This feedback and data involved in generating the second result may be used to retrain the machine learning model that generated the first result. Alternatively, member application 28 may calculate a ratio of the confidence percentage or weighted value of the first result and second result and determine that the first result is incorrect if the ratio exceeds a certain value. It is further understood that the confidence percentage or weighted value corresponding to the first and second result may be compared and/or analyzed in any other well-known manner to determine that the first result is incorrect.

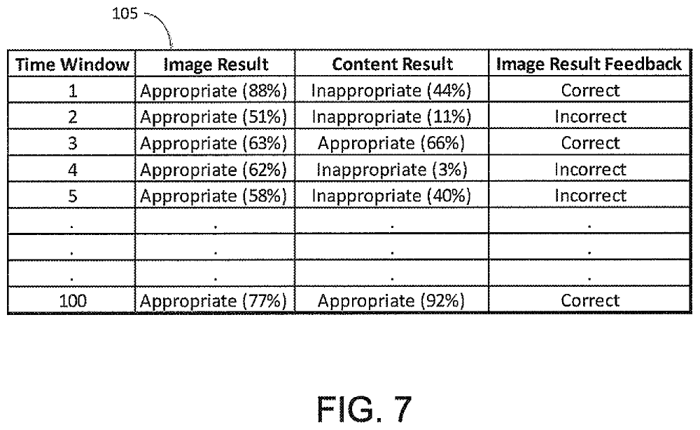

In another example, where two machine learning models are executed simultaneously and each generate a result and feedback is received from the teacher, assistant or administrator regarding at least one of the results, the results, feedback and/or related information (e.g. data upon which the result is based) may be used to train a new machine learning engine that generates a new result. As shown in FIG. 7, member application 28 may generate and maintain results record 105. Results record 105 may identify certain time periods or windows, the results generated during each time window including the type of result and any corresponding confidence percentage or weighted value, and any feedback received from the teacher, assistant or administrator, as well as any other relevant data that may be used to train a new machine learning engine.

A new machine learning model generated using machine learning engine 54 may be created using data generated by member application 28, such as the data identified in results record 105 shown in FIG. 7. The new machine learning model may consider both the image result and the content result and generate a new image result with an adjusted confidence percentage that accounts for the content result. For example, the machine learning model may be trained to decrease the confidence percentage where historical data in results record 105 involves incorrect image results for content results below a certain threshold. If the new image result is subsequently determined by the teacher, assistant or administrator to be incorrect, the new machine learning model may be updated and retrained with the feedback from the teacher, assistant or administrator. The new machine learning model may also be updated with additional feedback generated by the teacher, assistant or administrator regarding image results and content results.

Referring now to FIG. 8, behavior classification interface 141 is illustrated. Behavior classification interface 141 may assist a teacher, assistant and/or administrator in identifying the students that are misbehaving. In accordance with the steps set forth in FIG. 6, results will be generated by each member device 20 in classroom assistance system 10. Specially, as explained above, machine learning model 55 may be trained to determine if each student is misbehaving, and a result will be generated on each member device 20 indicative of whether each student is misbehaving. Behavior classification interface 141 is a graphical depiction of the aggregation of those results.

Behavior classification interface 141 may display a representation of each student on the class roster. For example, thumbnail images 142 may display a small image of each student and may optionally include an identifier for each student (e.g. name of each student, student identification number, etc.). Thumbnail image 142 may be a stock photo of each student or may be an image or short video clip of the student. Where a student has been determined by member device 20 to be misbehaving, thumbnail image 142 may be a short video clip or an image of the student misbehaving.

Behavior classification interface 141 may be partitioned into behaving section 143 and misbehaving section 144. If a result indicates that a student is behaving, thumbnail image 142 corresponding to the student using member device for which the result was generated will appear under behaving section 143. Conversely, if a result indicates that a student is misbehaving, thumbnail image 142 corresponding to the student using the member device for which the result was generated will appear under misbehaving section 144. A teacher or assistant using moderator device 30 and/or an administrator using administrator device 15 may quickly gauge the behavioral state of the classroom by reviewing only misbehaving section 144. Behavior classification interface 141 may alternatively include only misbehaving section 144 displaying only thumbnail images 142 of misbehaving students, permitting the teacher, assistant and/or administrator to quickly identify the students that are misbehaving. Alternatively, behavior classification interface 141 may include only a class roster section having thumbnail images 142 of each student in the class roster and may provide a visual indicator for students that are misbehaving. For example, thumbnail image 142 may have a green border for students that are determined to be behaving and a red border for students that are determined to be misbehaving.

As set forth in step 101 of FIG. 6, if it is determined that the result indicative of whether the student is behaving or misbehaving is incorrect, the teacher, assistant or administrator may reclassify that student manually. For example, using moderator input device 35, the teacher or assistant may click on or otherwise select thumbnail image 142 representing the particular student that will be reclassified and select from classification menu 145 that the current classification is incorrect. An administrator may similarly use administrator input device 45 in the same way. As is illustrated in FIG. 8, the teacher, assistant and/or administrator may select that the classification of Client 1 as behaving is incorrect. Alternatively, the teacher or assistant may drag the thumbnail representation of that student into the appropriate section (i.e., behaving section 143 or misbehaving section 144). As is explained with respect to steps 101-103 of FIG. 6, the feedback from the teacher or assistant will be communicated to member device 20 corresponding to the particular result that has been identified as incorrect and will be used to train the machine learning model to generate an updated machine learning model.

Moderator application 38 and/or administrator application 48 may be set to automatically archive the state of behavior classification interface 141 at any given time, making a record of those misbehaving at that given time. Behavior classification interface 141 may also be manually saved at any given time to make a record of those misbehaving at that time. The data may be saved locally on moderator device 30 and/or administrator device 15 or may be saved remotely on remote server 5. As the behavior of a student may change throughout the day, behavior classification interface 141 may generate an alert when a student is reclassified by member device 20. For example, if a student is labeled as behaving in the morning but then is determined to be misbehaving in the afternoon, behavior classification interface 141 may generate an alert to inform the teacher, assistant and/or administrator that a student that was behaving is now misbehaving. Similarly, an alert may be generated when a student that was identified as misbehaving is later determined to be behaving.

Referring now to FIG. 9, comprehension classification interface 171 is illustrated. Comprehension classification interface 171 may assist a teacher, assistant and/or administrator in identifying whether a student is comprehending the subject matter taught. In accordance with the steps set forth in FIG. 6, results will be generated by each member device 20 in classroom assistance system 10. Specially, as explained above, machine learning model 55 may be trained to determine if each student is comprehending the subject matter, and a result will be generated on each member device 20 indicative of whether each student is comprehending. Comprehension classification interface 171 is a graphical depiction of the aggregation of those results.

Comprehension classification interface 171 may display a representation of each student on the class roster. For example, thumbnail images 174 may display a photo or video clip of each student and include an identifier for each student. Comprehension classification interface 171 may list all students on the class roster in comprehension section 172 and may visually indicate on thumbnail image 174 whether each student is understanding the subject matter or is confused. If a result indicates that a student is understanding the subject matter, thumbnail image 174 corresponding to that student may include positive indicator 175, such as a checkmark, identifying the particular student as a student who understands the subject matter. Conversely, if a member device indicates that the student is not understanding the material, thumbnail image 174 corresponding to that student may include negative indicator 176, such as a question mark, identifying the particular student as a student who is confused by the subject matter.

Additionally, machine learning model 55 may be trained to identify if a student has a question. Machine learning model 55 and/or data analyzer 58 may analyze data for traits of a student that has a question such as a raised hand or an inquisitive facial expression. Member device 20 may inform moderator device 30 and/or administrator device 15 that a student has a question. If the student is determined to have a question, comprehension classification interface 171 may indicate that a particular student has a question by placing question identifier 177 on or adjacent to thumbnail image 174 corresponding to that student. For example, question identifier 177 may be the letter “Q” placed on Client 5 and Client 8.

A teacher or assistant using moderator device 30 and/or an administrator using administrator device 15 may quickly gauge the general comprehension of the students in classroom assistance system 10 by reviewing comprehension section 172 and comparing the number of positive indicators 175 to negative indicators 176. Comprehension classification interface 171 may further include statistics section 173 that displays various statistics and other information relating to class comprehension to permit a teacher or administrator to quickly gauge the degree of comprehension. For example, statistics section 173 may display understanding percentage 179, showing the percent of the class that is understanding the subject matter, and confused percentage 180, showing the percentage of the class that is confused by the subject matter. Statistics section 173 may further include question box 181 identifying the number of students with questions at a given time. Comprehension classification interface 171 may alternatively have a comprehension section populated with thumbnail images 174 of students identified as understanding the material as well as a confused section populated with thumbnail images 174 of students identified as being confused.

As set forth in step 101 of FIG. 6, if it is determined that a result indicative of whether a student is comprehending or not comprehending the material is incorrect, the teacher, assistant or administrator may reclassify that student manually. For example, using moderator input device 35, the teacher or assistant may click on or otherwise select thumbnail image 174 representing the particular student that will be reclassified and select from classification menu 178 that the current classification is incorrect. An administrator may similarly use administrator input device 45 in the same way. As is illustrated in FIG. 9, the teacher, assistant and/or administrator may select that the classification of Client 2 as comprehending is incorrect. As is explained with respect to steps 101-103 of FIG. 6, the feedback from the teacher or assistant will be communicated to member device 20 corresponding to the particular result that has been identified as incorrect and will be used to train the machine learning model to generate an updated machine learning model.

Moderator application 38 and/or administrator application 48 may be set to automatically archive the state of comprehension classification interface 171 at any given time, making a record of those comprehending and not comprehending the subject matter at that given time. Comprehension classification interface 171 may also be manually saved at any given time to make a record of those comprehending and not comprehending at that time. The data may be saved locally on moderator device 30 and/or administrator device 15 or may be saved remotely on remote server 5. As the student's understanding of the material may change throughout the day, comprehension classification interface 171 may generate an alert when a student is reclassified by member device 20. For example, if a student is labeled as understanding the material in the morning but then is determined to no longer understand the material in the afternoon, comprehension classification interface 171 may generate an alert to inform the teacher, assistant and/or administrator that a student that was understanding the material is no longer understanding the material. Similarly, an alert may be generated when a student that was labeled as not understanding the material is later labeled as understanding the material.

Referring now to FIG. 10, content classification interface 191 is illustrated. Content classification interface 191 may assist a teacher, assistant and/or administrator in identifying the students that are viewing or otherwise accessing inappropriate media content on member device 20. In accordance with the steps set forth in FIG. 6, content data representative of media content displayed or otherwise played or accessed on member device 20 will be obtained and ultimately processed by machine learning engine 54 running machine learning model 55. As explained above, machine learning model 55 may be trained to determine if the media content is appropriate, and a result will be generated on each member device 20 indicative of whether such content is appropriate. Content classification interface 191 is a graphical depiction of the aggregation of those results.

Content classification interface 191 may display a thumbnail image for each student on the class roster. For example, thumbnail images 192 may include an identifier for each student (e.g. name of each student, student identification number, etc.) and may include a representation of the display of member device 20. The representation of the display may be a still image (e.g., screen shot), a real time or near real time mirrored screen, or text representative of the media content displayed on member device 20. In another example, the representation may be a short video clip or sound clip of media content being played on member device 20. As explained above, member device 20 may be programmed to transmit this data to moderator device 30 and/or administrator device 15 upon generating a result indicative of the media content being inappropriate. Alternatively, member device 20 may be programmed to periodically transmit this data. Thumbnail image 192 may be enlarged by clicking on that particular thumbnail image.

Content classification interface 191 may be partitioned into appropriate content section 193 and inappropriate content section 195. If a result indicates that content displayed or played on member device 20 is appropriate, thumbnail image 192 corresponding to the student using the member device for which the result was generated will appear under appropriate content section 193. Conversely, if a result indicates that content displayed or played on member device 20 is inappropriate, thumbnail image 192 corresponding to the student using the member device for which the result was generated will appear under inappropriate content section 195. A teacher or assistant using moderator device 30 and/or an administrator using administrator device 15 may quickly survey the content being viewed or accessed by the students by reviewing appropriate content section 193 and inappropriate content section 195. Content classification interface 191 may alternatively include only inappropriate content section 195 displaying only thumbnail images 192 for students displaying or playing inappropriate content, permitting the teacher, assistant and/or administrator to quickly identify the students that are viewing or listening to inappropriate content. FIG. 11, discussed in more detail below, illustrates yet another alternative setup wherein the interface includes the entire class roster, discussed in more detail below.

As set forth in step 101 of FIG. 6, if it is determined that the result is incorrect, the teacher, assistant or administrator may reclassify that result manually using moderator device 30. For example, using moderator input device 35, the teacher or assistant may click on or otherwise select thumbnail image 192 corresponding to the content that should be reclassified and select from classification menu 194 that the current classification is incorrect. An administrator may similarly use administrator input device 45 in the same way. As is illustrated in FIG. 10 the teacher, assistant and/or administrator may select that the classification of “Client 1” is incorrect. Alternatively, the teacher, assistant and/or administrator may drag the thumbnail representation of that student into the correct section (i.e., appropriate content section 193 or inappropriate content section 195). As is explained with respect to steps 101-103 of FIG. 6, the feedback from the teacher, assistant and/or administrator will be communicated to member device 20 that generated the particular result that was identified as incorrect and will be used to train the machine learning model run on that member device to generate an updated machine learning model. Content classification interface 191 may also permit a teacher, assistant and/or administrator to close a website, disable a browser of a particular member device 20 or otherwise remotely control member device 20 via moderator device 30.

Moderator application 38 and/or administrator application 48 may be set to automatically archive the state of content classification interface 191 at any given time, making a record of the content being displayed or played on each member device in the class roster at that given time. Content classification interface 191 may also be manually saved at any given time to make a record of the content at that time. The record may be saved locally on member device 20, moderator device 30 and/or administrator device 15 or may be saved remotely on remote server 5. As the content displayed and played on member device 20 will change throughout the day, content classification interface 191 may generate an alert when a student is reclassified by member device 20. For example, if a student is labeled as displaying or playing appropriate content at one point and at a subsequent time is determined to be displaying or playing inappropriate content, content classification interface 191 may generate an alert to inform the teacher, assistant and/or administrator that a student is now displaying or playing inappropriate content.

Referring now to FIG. 11, content classification interface 201 is illustrated, which is an alternative content classification interface for assisting a teacher, assistant and/or administrator in identifying the students that are viewing or otherwise playing or accessing inappropriate media content on member device 20.

Content classification interface 201 may display a representation of each student on the class roster. For example, thumbnail images 205 may include an identifier for each student and may show a representation of the media content displayed or otherwise played or accessed by member device 20 at a given time. For example, thumbnail image 205 may include a screen shot of the display of member device 20 or may include the name of the website. Content classification interface 201 may visually indicate on thumbnail image 205 whether the content viewed or accessed by a student is inappropriate. For example, if a result indicates that content being displayed or accessed by member device 20 is inappropriate, thumbnail image 205 corresponding to that student may include negative indicator 204, such as an “X” through thumbnail image 205 and/or a bold border. Conversely, if a member device indicates that the media content being viewed or accessed is appropriate, thumbnail image 205 may remain unobstructed. The teacher, assistant and/or administrator may click on thumbnail image 205 to view a larger representation of the media content displayed or otherwise played by member device 20. The teacher, assistant and/or administrator, via moderator device 30 or administrator device 15, may request that member device 20 provide additional information or may instruct moderator device 30 to view the display of member device 20 in real time and even manipulate the display (e.g., close browser windows, stop or close a video or music player, or freeze the browser).

Similar to the approach described above with respect to FIG. 10, a teacher, assistant and/or administrator, via moderator device 30 or administrator device IS, may reclassify content determined to be inappropriate as appropriate. For example, using moderator input device 35, the teacher or assistant may click on or otherwise select thumbnail image 205 representing the particular content that should be reclassified and select from classification menu 208 that the current classification is incorrect. In the example illustrated in FIG. 11, a history teacher may determine that Client 2's use of the www.history.com is appropriate and thus may reclassify this content using classification menu 208. Clicking on media content (e.g., a website) in summary section 203 may also generate classification menu 208. Content classification interface 201 may further include an option to close the website, disable the browser of that particular member device 20 and/or remotely control member device 20 via moderator device 30.

Content classification interface 201 may further include summary section 203 that displays various statistics relating to class comprehension to permit a teacher or administrator to quickly gauge the content the class is viewing or otherwise playing on each member device 20. For example, summary section 203 may display inappropriate percentage 209, showing the percent of the class that is viewing or otherwise accessing media content that is determined to be inappropriate. Summary section 203 may also include inappropriate website section 210 identifying the websites being accessed by the students that are determined to be inappropriate.

Member application 28 may be programmed to automatically shut down a website, browser, application or the entire member device if it determines that certain inappropriate content is being displayed or otherwise accessed by member device 20. For example, member application 28 may be programmed to shut down member device 20 if pornographic content is detected. Alternatively, member application may be programmed to take certain action if a result involves a confidence value or weighted value below a certain threshold. For example, if the value exceeds a certain threshold, member application 28 may cause member device 20 to shut down a website, browser, or application corresponding to the inappropriate content, or in some cases may be programmed to shut down the entire member device. Summary section 203 may include auto-shutdown section 211 which may list the member devices which have been automatically shut down or for which a website or browser has been automatically closed. Content classification interface 201 may display shutdown indicator 206 for thumbnail image 205 corresponding to member devices that have experienced auto-shutdown. Shutdown indicator 206 may, for example, be a blacked-out image or a black and white image. The teacher, assistant and/or administrator may click on auto-shutdown section 211 to observe the content that caused the auto-shutdown. An alert may be generated by content classification interface 201 to inform the teacher, assistant and/or administrator that an auto-shutdown has taken place. Alternatively, an alert may be generated by classification interface 201 seeking permission from the teacher, assistant and/or administrator to shut down a website, browser, application or the entire member device.

Referring now to FIG. 12, behavior classification interface 231 is illustrated. Behavior classification interface 231 may assist a teacher, assistant and/or administrator in identifying the students that are acting inappropriately. Results may be generated using both image/audio data and content data, as discussed above. Behavior classification interface 231 includes confidence value 236 which identifies the degree to which classroom assistance system 10 is confident in the results generated. Confidence value 236 is an average confidence percentage created by averaging a confidence percentage corresponding to a result based on image/audio data and a confidence percentage corresponding to a result based on content data. In this example, a low confidence value corresponds to a student acting inappropriately and a high confidence value corresponds to a student acting appropriately. Behavior classification interface 231 is a graphical depiction of the aggregation of the results for each student.

Behavior classification interface 231 may display thumbnail image 232 for each student. Thumbnail image 232 may either be placed into appropriate behavior section 233 or inappropriate behavior section 235 depending on the results generated. Thumbnail image 232 of each student may be ordered according to confidence value 236 and may include an identifier for each student (e.g. name of each student, student identification number, etc.). In this example a confidence threshold may be set at 70% such that a confidence value at or above 70% suggests that the student is acting appropriately and below 70% suggests that the student is acting inappropriately. Thumbnail image 232 of each student may be a screen shot of the student's display or may be an image or video of the student. As explained above, member device 20 may be programmed to transmit this data to moderator device 30 and/or administrator device 15 upon generating a result.

As explained in greater detail with respect to FIGS. 8-10, if the teacher, assistant or administrator determines that the result is incorrect, the teacher, assistant or administrator may reclassify that result manually using moderator device 30 to generate classification menu 234 and selecting that the classification is incorrect. Alternatively, the teacher, assistant and/or administrator may drag the thumbnail image corresponding that student into the correct section (i.e., appropriate behavior section 233 or inappropriate behavior section 235). The feedback from the teacher, assistant and/or administrator will be communicated to member device 20 that generated the result identified as incorrect and will be used to train the machine learning models corresponding to the result to generate updated machine learning models.

Referring now to FIGS. 12A-12F, exemplary graphical representations of analytics generated by classroom assistance system 10 are illustrated. Graphical representations and various statistics relating to the data generated in implementing the steps set forth in FIG. 6 may be generated by moderator device 30 and/or administrator device 15 using statistics/graphics generator 65 and statistics/graphics generator 75, respectively. The graphical representations and statistics may be directed to a single student or member device, multiple students or member devices, or even may compare different teachers or students and member devices from different classrooms. Graphical representations may be generated by either moderator device 30 or administrator device 15 using data available on any device in classroom assistance system 10 including member device 20, moderator device 30, administrator device 15 and/or remote server 5. While FIGS. 12A-12F set forth exemplary graphical representations, it of course is understood that any data generated by classroom assistance system 10 may be used to generate graphical representations and statistics using well-known graphical and statistical methods and techniques.

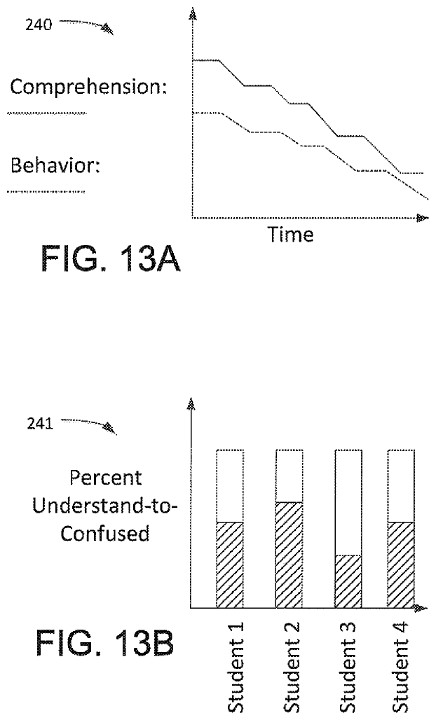

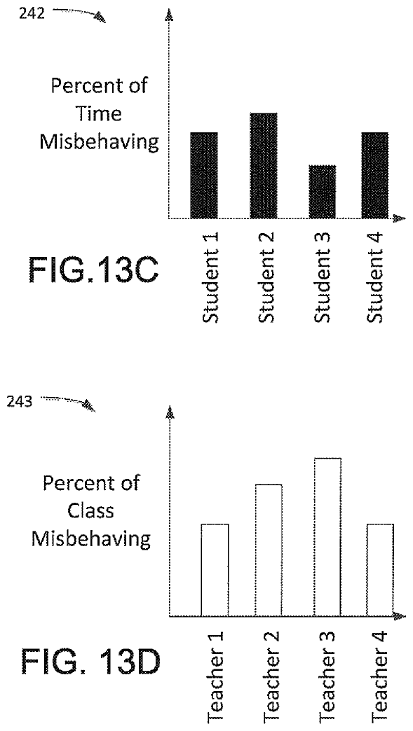

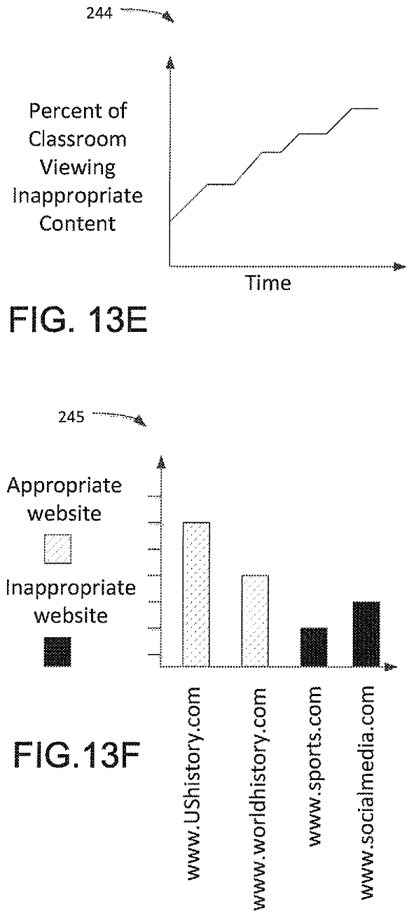

Referring now to FIG. 13A, graphical representation 240 illustrates a particular student's comprehension and behavior over a certain period of time. For example, graphical representation 240 may represent a student's average comprehension and behavior over a single school day. Graphical representation 240 may suggest that this particular student is having trouble paying attention as the day progresses and further suggest that the student tends to misbehave as he or she becomes disinterested in the subject matter. Similar graphical representations may depict a student's behavior and/or comprehension over a semester or at a particular time during the day.

Referring now to FIG. 13B, graphical representation 241, illustrates the average comprehension of multiple students in a given classroom or school. Graphical representation 241 may help a teacher, assistant or administrator identify students that are struggling to understand the subject matter. For example, Student 3 is, on average, more confused than his peers and may require additional attention or resources. Similar graphical representations may illustrate the student's average comprehension for a given subject matter or at a certain time in the day.

Referring now to FIG. 13C, graphical representation 242 illustrates the average percent of time a student is misbehaving over a given period of time. For example, graphical representation 242 illustrates that Student 2 is misbehaving more often that his or her peers. Graphical representation 242 may be used to identify students that are disturbing the classroom experience and inform the teacher or assistant where to focus his or her attention. Similar graphical representations may illustrate the student's percent of time misbehaving for a given subject matter or at a certain time in the day.

Referring now to FIG. 13D, graphical representation 243 illustrates the average percent of the classroom that is misbehaving at any given time or over a certain period of time for each teacher in classroom assistance system 10. Administrator device 15 may be the only device in classroom assistance system 10 that has the permission to access data from multiple classrooms and generate this graphical representation. Graphical representation 243 may be used determine which teachers are having trouble keeping order in their classroom and may be compared to average comprehension or test scores in that classroom to determine if there is a correlation between the two.

Referring now to FIG. 13E, graphical representation 244 illustrates the percent of the classroom that is viewing inappropriate content over a certain period of time. For example, graphical representation 244 may represent the percent of the classroom that is viewing inappropriate content over a single school day. Graphical representation 244 may suggest that this classroom tends to view more inappropriate content as the day progresses, further suggesting that the students become disinterested in the subject matter as the day progresses. Similar graphical representations may include data from different classrooms to compare the content viewed in different classrooms throughout the day.

Referring now to FIG. 13F, graphical representation 245 illustrates both the appropriate and inappropriate websites observed in a particular classroom and indicates how many students are viewing each website. In the example illustrated in FIG. 13F, the students are in history class and the most viewed websites are www.UShistory.com and www.wordhistory.com which are determined to be appropriate content for the history class. Additionally, some students are viewing www.sports.com and www.socialmedia.com which are determined to be inappropriate content. Similar graphical representations may show the websites visited by a single student over a certain period of time and the number of views for each website.

It should be understood that any of the computer operations described herein above may be implemented at least in part as computer-readable instructions stored on a computer-readable memory. It will of course be understood that the embodiments described herein are illustrative, and components may be arranged, substituted, combined, and designed in a wide variety of different configurations, all of which are contemplated and fall within the scope of this disclosure.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A classroom assistance system comprising:
a plurality of member devices, each member device comprising;
a processor;
an image input device configured to generate image data;
a display configured to display content data;
a machine learning model; and
a machine learning engine configured to run on the processor and process at least one of image data or content data using the machine learning model to generate a result,
wherein each member device of the plurality of member devices corresponds to a student.

2. A classroom assistance system comprising:
a plurality of member devices, each member device comprising;
a processor;
an image input device configured to generate image data;
a display configured to display content data;
a data analyzer configured to run on the processor and analyze at least one of image data or content data to generate analyzed data;
a machine learning model; and
a machine learning engine configured to run on the processor and process analyzed data using the machine learning model to generate a result; and
a moderator client device comprising;
a processor; and
a display configured to display a user interface,
wherein each member device of the plurality of member devices is used by a student and the moderator device is used by a teacher,
wherein each member device of the plurality of member devices is in communication with the moderator device and each member device communicates the result generated on the member device to the moderator device, and
wherein the user interface is configured to run on the processor and display each result generated by the plurality of member devices.

3. The classroom assistance system of claim 2, wherein at least one result is indicative of behavior of the student using the member device that generated the at least one result.

4. The classroom assistance system of claim 2, wherein at least one result is indicative of the comprehension of the student using the member device that generated the at least one result.

5. The classroom assistance system of claim 2, wherein at least one result is indicative of whether content data is appropriate for display on the display of the member device that generated the at least one result.

6. The classroom assistance system of claim 2, wherein the moderator device further comprises a moderator input device configured to generate input data, wherein the input data identifies at least one of the results generated by the plurality of member devices as incorrect.

7. The classroom assistance system of claim 6, wherein the member device that generated the result identified as incorrect is configured to receive the input data from the member device and train the machine learning model that generated the result identified as incorrect using the input data to produce an updated machine learning model.

8. The classroom assistance system of claim 2, wherein each member device of the plurality of member devices is configured to automatically communicate to the moderator device at least a portion of the image data or content data.

9. The classroom assistance system of claim 2, wherein the member device is configured to communicate at least a portion of image data or content data to the moderator device at the request of the moderator device.

10. The classroom assistance system of claim 8 or 9, wherein the user interface is configured to display the at least a portion of the image data or content data.

11. The classroom assistance system of claim 2, wherein the member device is configured to automatically cause the member device to shut down if a certain result generated.

12. The classroom assistance system of claim 2, wherein the moderator device is configured to cause the member device to shut down.

13. The classroom assistance system of claim 2, further comprising an administrator device, the administrator device comprising:
an administrator processor; and
a display configured to run an administrator user interface,
wherein each member device of the plurality of member devices is in communication with the administrator device and each member device communicates the result generated on the member device to the administrator device, and
wherein the administrator user interface is configured to run on the administer processor and display each result.

14. The classroom assistance system of claim 13, wherein the administrator device further comprises an administrator input device configured to generate administrator input data, wherein the administrator input data identifies at least one of the results generated by the plurality of member devices as incorrect.

15. The classroom assistance system of claim 14, wherein the member device that generated the result identified as incorrect is configured to receive the input data from the administrator device and train the machine learning model that generated the result identified as incorrect using the input data to produce an updated machine learning model.

16. The classroom assistance system of claim 2, further comprising a remote server, wherein the remote server is in communication with at least one of the plurality of member devices or moderator device and is configured to store at least one of image data, content data, analyzed data and results.

17. The classroom assistance system of claim 2, wherein the moderator device further comprises an access point configured to wirelessly connect the moderator device and the plurality of member devices.

18. A method for implementing a classroom assistance system involving a plurality of member devices and a moderator device, the method comprising:
at each member device of the plurality of member devices, obtaining at least one of image data or content data and analyzing the image data or content data to generate analyzed data;
at each member device of the plurality of member devices, applying the analyzed data to a machine learning engine executed locally on each member device to produce a result specific to that member device;
at each member device of the plurality of member devices, communicating the result to the moderator device;
at the moderator device, receiving each result from each member device; and
at the moderator device, displaying each result on a user interface of the moderator device.

19. The method of claim 18, further comprising:
at the moderator device, identifying at least one result as incorrect using a moderator input device to generate input data;
at the moderator device, communicating the input data to the member device that generated the result identified as being incorrect; and
at the member device, training the machine learning model that generated the result identified as being incorrect with the input data, resulting in an updated machine learning engine.

20. The method of claim 19, wherein the result identified as being incorrect is indicative of at least one of: the behavior of a student using the member device that generated the result, the comprehension of the student using the member device that generated the result, or whether the content data is inappropriate for display on the member device.
